(19) United States
(12) Patent Application Publication
(10) Pub. No.: US 2008/0170255 A1
(43) Pub. Date: Jul. 17, 2008

(54) Image output terminal performance estimate at composition engine

(75) Inventor: Christopher A. Mazur, Henrietta, NY (US)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/654,184

(22) Filed: Jan. 16, 2007

(51) Int. Cl. G06F 3/12; G06K 15/00

(52) U.S. Cl. 358/1.15; 358/1.18

(57) ABSTRACT

A variable information printing system includes: an image output terminal having a raster image processor, the raster image processor providing raster image processing of a data stream received thereby; a composition engine for composing a variable information print job, the composition engine including an emitter that provides the data stream to the raster image processor in a page description language format in accordance with the variable information print job; and, an application program interface implemented between the emitter and the raster image processor, the application program interface being operable to provide at the composition engine a forecast of the image output terminal's performance in connection with the variable information print job.

### BACKGROUND

The present specification relates to the digital printing and/or publishing arts. Particular application is found in conjunction to with variable data or variable information (VI) printing, and particular reference will be made thereto. However, it is to be appreciated that aspects of the subject matter disclosed herein are equally amenable to other print-on demand and/or similar applications.

In general, variable data printing or VI printing, as it is understood in the art, is a form of on-demand printing that involves the printing of a plurality of documents or other pieces in which some content or elements (e.g., text, graphics or images) change from piece to piece. Commonly, the documents also include other content or elements that remain unchanged from piece to piece. The changing content or elements are referred to as the variable data or VI, and the unchanging content or elements are referred to as the static data or static information. For example, a set of personalized letters, each with the same basic layout (i.e., static data), can be printed with a different name and address (i.e., VI) on each letter. Commonly, VI printing is used in direct marketing, customer relationship management, advertising and other like printing and/or publishing applications. Often at or near production speeds, VI printing enables the customization of a large number of documents via digital printing technology. For example, instead of producing many identical copies of the same document that is delivered to various potential customers, VI printing allows one to print many unique documents with customized information or content for each customer.

Typically, a VI printing system includes a composition engine where page or document layouts are created for a specific job. The composition function determines where selected VI and/or static information will appear in a document or on a page. Commonly, the composition engine is implemented as a software application running on a suitable computer operatively connected to an image output terminal (IOT). The IOT is generally configured to include: (i) a print engine that applies toner, ink or another suitable marking agent to the paper or other substrate on which the document or page is formed; and, (ii) a digital front end (DFE) or raster image processor (RIP) or other like functional element. In a typical embodiment, the composition engine includes an emitter that supplies a data steam to the DFE or RIP which in turn rasterizes the data to prepare it for the print engine.

Various Page Description Languages (PDLs), e.g., such as PostScript, VIPP (Variable-data Intelligent PostScript Printware), VPS (Variable Print Specification), PPML (Personalized Print Mark-up Language), Fiery FreeForm, etc., are known to be utilized in certain VI printing workflows. Some of these PDLs employ cached or re-usable elements as is understood in the art. Notably, for any given job, the PDL output by the emitter can be configured in a variety of different ways at the composition engine and/or at the DFE. However, certain configurations allow the PDL to be processed at the DFE or RIP into a print ready format more efficiently than other configurations. That is to say, e.g., different configurations of the job can lead to varying levels of performance at the IOT and/or print engine. Nevertheless, absent a processing path execution of a target VI job, there has been heretofore no way to determine IOT/print engine performance under the stress of VI job runs, which are often highly complex.

For example, depending on the configuration of a particular VI job, the IOT and/or print engine may perform at less than their rated speed. However, heretofore there has been no suitable way to forecast the less than optimal performance without executing the job through the processing path. Of course, the operator may become frustrated upon experiencing the lowered performance or slower speed of the IOT/print engine, which can lead to further time consuming re-working and/or redesigning of the VI job at the composition engine. Continually returning to the composition engine to redesign the job and then running it thought the processing path in an attempt to achieve optimal performance of the IOT/print engine, however, can be inefficient.

Accordingly, a new and improved method and/or system for forecasting and/or estimating IOT/print engine performance in connection with a particular VI printing job is disclosed that overcomes the above-referenced problems and others.

### BRIEF DESCRIPTION

In accordance with one embodiment, a variable information printing system is provided. The system includes: an image output terminal having a raster image processor, the raster image processor providing raster image processing of a data stream received thereby; a composition engine for composing a variable information print job, the composition engine including an emitter that provides the data stream to the raster image processor in a page description language format in accordance with the variable information print job; and, an application program interface implemented between the emitter and the raster image processor, the application program interface being operable to provide at the composition engine a forecast of the image output terminal's performance in connection with the variable information print job.

In accordance with another embodiment, a method is provided for forecasting the performance of an image output terminal for a proposed design of a variable information print job. The method includes: providing the proposed design of the print job at a composition engine, the print job having associated therewith a plurality of records indicating values for variable information in the print job; selecting a sample subset of the records to produce a sample job representative of the entire variable information print job; and, submitting the sample job to the image output terminal to measure the performance thereof with respect to the sample job.

Numerous advantages and benefits of the pertinent subject matter disclosed herein will become apparent to those of ordinary skill in the art upon reading and understanding the present specification.

### BRIEF DESCRIPTION OF THE DRAWINGS

The subject matter of the present specification may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary printing system suitable for practicing aspects of the present inventive subject matter.

FIG. 2 is a flow chart showing an exemplary process embodying aspects of the present inventive subject matter.

### DETAILED DESCRIPTION

For clarity and simplicity, the present specification shall refer to structural and/or functional elements, relevant standards and/or protocols and other components and/or features that are commonly known in the digital printing/publishing art without further detailed explanation as to their configuration or operation except to the extent they have been modified or altered in accordance with and/or to accommodate the exemplary embodiment(s) presented herein.

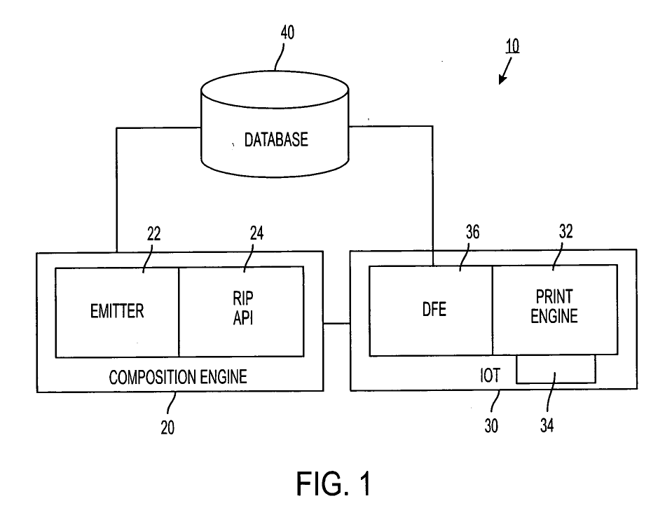

With reference to FIG. 1, a VI printing system 10 includes a composition engine 20 and an IOT 30. Suitably, the IOT 30 includes a print engine 32 that applies toner, ink or another suitable marking agent to a substrate 34 (e.g., paper or another suitable substrate) on which a document or page is formed. Optionally, the print engine 32 is a monochromatic or color print engine, e.g., including one or more colors of marking agent that are selectively applied to the substrate 34. As illustrated, the IOT 30 also includes a DFE 36 or RIP or other like functional element that performs raster image processing in accordance with a received data stream. Optionally, the DFE 36 includes a RIP subsystem. In any event, the rasterized data is in turn supplied by the DFE 36 or RIP or other like function element to the print engine 32 which applies the marking agent to the substrate 34 in accordance therewith.

Suitably, the composition engine 20 is implemented as a software application running on a computer or other workstation operatively connected to the IOT 30 in the usual manner. The composition engine 20 optionally includes a graphical user interface (GUI) or other suitable user interface that a designer or other operator selectively employs to compose or otherwise create a layout for a VI print job. Alternately, the designer may create or otherwise generate a new layout from scratch for the particular job; or, the designer may select and/or optionally edit a previously created layout that has been stored in a suitable storage device and/or location that is accessible by the composition engine 20. As illustrated, the composition engine 20 includes an emitter 22 that supplies image data to the IOT 30 (e.g., in a PDL format) in accordance with the created composition and/or programming for the VI print job. Suitable PDLs emitted by the emitter 22 include, but are not limited to, PostScript, VIPP (Variable-data Intelligent PostScript Printware), VPS (Variable Print Specification), PPML (Personalized Print Mark-up Language), Fiery FreeForm, etc.

As can be appreciate, a typical VI print job produces a plurality of customized documents or other like pieces that generally have a common layout. For example, the documents may be single page or multipage pieces such as customized flyers, letters, brochures, advertizing or promotional materials, etc. Suitably, the documents include VI, i.e., variable content or elements (e.g., text, graphic, images, etc.) that vary from document to document. Optionally, the documents also include static data, i.e., static content or elements (e.g., text, graphics, images, etc.) that remain unchanged from document to document. Using the composition engine 20, the designer creates or otherwise generates a layout or template for the job that determines where and/or how the VI and/or static data is to appear in the documents.

In the illustrated embodiment, values for the VI are obtained from a database (DB) 40. Suitably, the DB 40 includes a plurality of records containing or otherwise indicating the values for the VI to be included in the documents produced by the particular VI print job. For example, each record contains or otherwise indicates the particular values of the VI to be include in one of the customized documents produced by the VI print job. That is to say, a first record contains or otherwise indicates the particular values of the VI to be included in a first document, a second record contains or otherwise indicates the particular values of the VI to be included in a second document, a third record contains or otherwise indicates the particular values of the VI to be included in a third document, and so on. Optionally, the values contained or otherwise indicated in the records included the DB 40 are extracted or otherwise obtained by the composition engine 20 and merged with or otherwise combined into the data stream output by the emitter 22 to the IOT 30. Alternately, these values are obtained by the DFE 36 and merged with or otherwise combined into the data received from the emitter 22.

Suitably, selected content and/or elements of static data are defined or otherwise contained in the layout or template produced with the composition engine 20. Alternately, selected content or elements of static data are contained in a suitable storage device and/or location that is accessible by the composition engine 22 with the layout or template merely including a reference or pointer thereto. Optionally, when the VI job is submitted to the IOT 30, the composition engine 22 obtains the static data from the referenced storage device and/or location and merges or otherwise combines the obtained static data into the data stream output by the emitter 22 to the IOT 30. Alternately, the reference or pointer itself is provided in the data steam emitted by the emitter 22 and the DFE 36 obtains the referenced static data from the indicated storage device and/or location and merges or otherwise combines the obtained static data with the received data steam from the emitter 22.

In a suitable embodiment, the manner in which the VI job workflow is executed is in part a function of how the designer programs the job, i.e., how the designer codes the job or otherwise composes the layout or template for the VI print job with the composition engine 20. For example, depending on how the VI print job is programmed, the combination of VI and static data may be executed at the composition engine 20 such that the combined data is emitted by the emitter 22 to the IOT 30, or the static data alone may be emitted by the emitter 22 to the IOT 30 and the VI is then combined therewith by the DFE 36; selected elements of static data may be included in the layout or template created at the composition engine 20, or they may be stored elsewhere and obtained by either the composition engine 20 for inclusion in the data stream emitted by the emitter 22 or they may be obtained by the DFE 36; or any combination of the foregoing may take place. Of course, other factors in the design of a particular VI print job and/or the configuration of the PDL corresponding thereto may also affect the workflow and/or the manner in which the job is executed. In any event, the design of the VI print job at the composition engine 20 can affect the ultimate performance of the IOT 30. That is to say, the configuration of the PDL representing the job can affect the speed at which the IOT 30 executes the job.

Accordingly, the composition engine 20 also includes a RIPAPI (RIP Application Program Interface) 24 that estimates or forecasts the performance of the target IOT 30 for a particular VI print job without having to actually execute the job through the processing path. As shown, the API 24 is a bi-directional API implemented between the emitter 22 and the target IOT 30. Suitably, the API 24 is programmed or otherwise provisioned with the operating characteristics and/or rated speed of the target IOT 30.

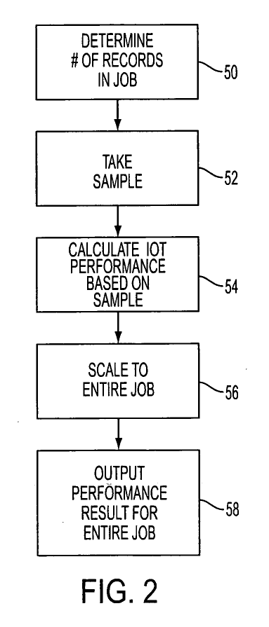

With reference now to FIG. 2, an exemplary operation of the API 24 will now be described. Suitably, after designing, composing, programming, selecting and/or otherwise preparing a desired VI print job with the composition engine 20, the designer or end user selects an option to implement the function of the API 24. In response to the user choosing to implement the function of the API 24, at step 50, the API determines the total number of records (e.g., contained in the DB 40) included in the job at hand. At step 52, the API 24 selects a subset of representative sample records from the all the records to be included in the job. Suitably, the selected subset includes less records than the total number of record to be included in the job. That is to say, the selected subset is a representative fraction of the total. Optionally, the number of record included in the subset is sufficiently large enough to be a statistically meaningful representation of the entire job but sufficiently small to permit a sample job including the subset of records to be evaluated in a suitably brief time.

At step 54, the API 24 calculates the performance of the IOT 30 using the selected subset of record. More specifically, using the PDL configuration and/or design of the VI job present in the composition engine 20 (i.e., the same programming in place for the target VI job under consideration), the API 24 creates a sample job including the selected subset of records. The API 24 then submits or otherwise calls in the sample job (optionally in a non-interactive manner) to the DFE 36 or RIP or other like functional element of the target IOT 30 to gain an actual performance measurement for executing or processing the sample job. For example, the API 24 measures the time it takes the DFE 36 or RIP or RIP subsystem or other like functional element to perform the raster image processing for the sample job. The calculated performance is in this case a measurement of the performance of the actual DFE 36 or RIP or RIP subsystem or other like functional element of the target IOT 30. Optionally, the API 24 flags the sample job as such and accordingly the DFE 36 recognizes the job submitted by the API 24 as a sample job and does not relay the rasterized data to or otherwise engage the print engine 32 to print the sample job. Rather, the DFE 36 merely signals the API 24 when ripping is completed. To make the performance evaluation for the sample job, the API 24 calculates or otherwise determines the time lapse between submission of the sample job and the completion of the ripping.

Having obtained the performance evaluation for the sample job, at step 56, the API 24 scales up the performance evaluation for the sample job to reflect the performance estimation or forecast for the entire job. For example, if take x time to process a sample job including 1/n of the records contained in the entire job, then the performance estimate or forecast for the entire job is calculated by the API 24 as n times x. Finally, at step 58, the performance estimate or forecast for the entire job is output to the end user, e.g., displayed on monitor or other display device associated with the composition engine 20. Optionally, the performance forecast indicates the estimated time it will take the target IOT 30 to complete or otherwise process the entire job, or alternately, it may be expressed as a percentage or fraction of the IOT's rated speed. For example, the output performance forecast may indicate that the entire job will take x amount of time for the IOT 30 to complete or process, or alternately, the output performance forecast may indicate that the IOT 30 will perform at x % of its rated speed for the job under consideration.

In one suitable embodiment, the composition engine 20 is optionally operatively connected to a plurality of IOTs similar to IOT 30. Each IOT, however, may have different DFEs or RIPs that respond differently to a particular VI print job. Accordingly, the end user may instruct the API 24 to target one or more of the different IOTs with the sample job, or the API 24 may be automatically programmed or otherwise provisioned to target any one or more of the IOTs with a given sample job. In this manner, the end user is able to retrieve the performance evaluations for the VI job against multiple potential target IOTs. Accordingly, when selecting the IOT that is ultimately going to be used for the job, the end user may select the IOT with the best performance estimate for that particular job.

In any event, it is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to exemplary embodiments. Nevertheless, it is to be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A variable information printing system comprising:
an image output terminal including a raster image processor, said raster image processor providing raster image processing of a data stream received thereby;
a composition engine for composing a variable information print job, said composition engine including an emitter that provides the data stream to the raster image processor in a page description language format in accordance with the variable information print job; and,
an application program interface implemented between the emitter and the raster image processor, said application program interface being operable to provide at the composition engine a forecast of the image output terminal's performance in connection with the variable information print job.

2. The variable information printing system of claim 1, wherein the raster image processor is implemented in a digital front end.

3. The variable information printing system of claim 2, wherein the image output terminal further comprises:
a print engine that applies a marking agent to a substrate in accordance with rasterized data received from the raster image processor.

4. The variable information printing system of claim 1, wherein the variable information print job produces a plurality of documents including at least one element of variable information that varies from document to document.

5. The variable information printing system of claim 4, further comprising:
a database having a plurality of records, each record indicating a value for the variable information in one of the documents.

6. The variable information printing system of claim 5, wherein the application program interface selects a sample subset of the records to produce a sample job representative of the entire variable information print job.

7. The variable information printing system of claim 6, wherein the application program interface submits the sample job to the raster image processor to measure the performance thereof with respect to the sample job.

8. The variable information printing system of claim 7, wherein the application program interface proportionally scales the measured performance of raster image processor with respect to the sample job to produce an estimated performance of the raster image processor with respect to the entire variable information print job.

9. The variable information printing system of claim 8, wherein the forecast of the image output terminal's performance in connection with the variable information print job is based upon the estimated performance of the raster image processor with respect to the entire variable information print job.

10. A method for forecasting performance of an image output terminal for a proposed design of a variable information print job, said method comprising:
a) providing the proposed design of the print job at a composition engine, said print job having associated therewith a plurality of records indicating values for variable information in the print job;
b) selecting a sample subset of the records to produce a sample job representative of the entire variable information print job; and,
c) submitting the sample job to the image output terminal to measure the performance thereof with respect to the sample job.

11. The method of claim 10, said method further comprising:
d) proportionally scaling the measured performance of the image output terminal with respect to the sample job to produce an estimated performance of the image output terminal with respect to the entire variable information print job.

12. The method of claim 11, wherein the forecast performance of the image output terminal is based upon the estimated performance of the image output terminal with respect to the entire variable information print job.

13. The method of claim 12, said method further comprising:
e) output the forecast performance at the composition engine.
